(19) United States
(12) Patent Application Publication
(10) Pub. No.: US 2021/0131155 A1
(43) Pub. Date: May 6, 2021

(54) MOTOR VEHICLE DOOR WITH ARRESTER DEVICE

(71) Applicant: Kiekert AG, Heiligenhaus (DE)

(72) Inventors: Jörg Linnenbrink, Wuppertal (DE); Stefan Adamik, Velbert (DE); Andreas Ziganki, Mettmann (DE); Uwe Reddmann, Essen (DE); Johannes Ehrlich, Wiesenbronn (DE); Holger Böse, Würzburg (DE)

(21) Appl. No.: 16/472,236

(22) PCT Filed: Dec. 20, 2017
(86) PCT No.: PCT/DE2017/101090

§ 371 Date: Jun. 21, 2019

(30) Foreign Application Priority Data
Dec. 22, 2016 (DE) 10 2016 015 409.8

(51) Int. Cl. E05C 17/56

(52) U.S. Cl. CPC E05C 17/56; E05Y 2900/531

(57) ABSTRACT

A motor vehicle door includes an arrester device having a magneto-rheological fluid for holding the motor vehicle door in position, and a coil for solidifying the magneto-rheological fluid that is disposed adjacent to a liquid-tight interior space, with the interior space containing one or more components which can be moved relative to other components in the interior space. A relative movement between these components is slowed down by solidifying the magneto-rheological fluid and the slowing down of the relative movement causes the motor vehicle door to be held in position. The coil is part of a switchable hard magnet which is selected such that a sedimentation-stable, magneto-rheological fluid is obtained. The motor vehicle door may thus be reliably held in a freely selectable position.

The invention relates to a motor vehicle door comprising an arrester device, that includes a magneto-rheological fluid for holding the motor vehicle door in position. The invention further relates to an arrester device for holding the motor vehicle door or flap in an open position.

A magneto-rheological fluid is a fluid that solidifies when a sufficiently strong magnetic field is generated. A magneto-rheological fluid comprises a carrier fluid with magnetically polarizable particles dispersed therein. The generation of a magnetic field causes the particles to polarize. Aligning the polarized particles renders the suspension viscous. The greater the field strength of the generated magnetic field, the more viscous the magneto-rheological fluid.

This property of a magneto-rheological fluid is used with couplings and the like. If the magneto-rheological fluid is in a non-hardened state, then one part of the coupling can be moved relative to the other part of the coupling. As the magneto-rheological fluid solidifies, this slows down the movement capacity.

Couplings with magneto-rheological substances are for example presented in the printed publications DE 102015204688 A1, WO 2013053344 A1, DE 102005011826 A1, US 2012085613 A, DE 102008022268 A1, DE 102007020887 A1, WO 07022910 A2.

In the case of motor vehicle doors, it is common to be able to keep them in an open position. A motor vehicle door can therefore regularly be held in a half-opened position. To swivel a motor vehicle door out of such a half-opened position requires increased force to be applied. By keeping it in a half-opened position, this should prevent a motor vehicle door from accidentally opening further, which can cause damage in the event of a collision with an adjacent object such as a wall or motor vehicle.

The drawback of common solutions is that a motor vehicle door cannot be held in a freely selectable open position.

The printed publication WO 2013/053344 A1 presents an arrester device for motor vehicle doors whereby a motor vehicle door can be held in a freely selectable open position. The arrester device hereby comprises a chamber filled with a hydraulic medium, displacement body and valve. Such arrester devices have however not proven themselves in practice. The holding force in particular is often too low.

The object of the invention is to provide a motor vehicle door with an arrester device that is technically simple, reliable and can permanently hold the motor vehicle door in the desired open position.

The object of the invention is solved by a motor vehicle door with the characteristics of claim 1. An arrester device for such a motor vehicle door includes the characteristics of the additional claim. Advantageous designs are a result of the dependent claims.

In order to solve the task, a motor vehicle door demonstrates an arrester device that includes a magneto-rheological fluid for holding the motor vehicle door in position. The arrester device contains a switchable hard magnet with a coil for solidifying the magneto-rheological fluid. The coil is disposed adjacent to a liquid-tight interior space. The interior space contains components that can be moved relative to other components in the interior space. A relative movement between these components can at least be slowed down by solidifying the magneto-rheological fluid. If the fluid is sufficiently solidified, this can prevent a relative movement. The slowing down or prevention of the relative movement causes the motor vehicle door to be held in position.

A motor vehicle door can hereby be held in position when much force is applied. Furthermore, holding the motor vehicle door in any open position is also continuously possible. The magneto-rheological fluid is solidified by generating a relevant tension on the coil.

In an advantageous version, the switchable hard magnet is selected such that a minimum magnetic force is obtained so that the magneto-rheological fluid is sedimentation-stable. The adverse deposit of particles and with that any associated malfunctions and/or impediments, are thus reliably prevented. The coil is part of a switchable hard magnet which is selected such that a sedimentation-stable, magneto-rheological fluid is obtained.

The required minimum magnetic force is provided in a version by a permanent magnet of the switchable hard magnet. It is however also possible that the minimum magnetic force can be or is set by means of a current flowing through the coil, in order to thus obtain a sedimentation-stable, magneto-rheological fluid. The flowing current, a pulsating electric current is advantageous in order to hereby, with the aid of periodic current pulses and with little electrical power, prevent sedimentations in the long term and with that any associated faults or impediments.

In an advantageous version of the invention, a sensor is present that can detect sedimentations in the magneto-rheological fluid. This can be an optical sensor. It is however also possible for the sensor to detect sedimentations through conductivity measurements. Dependent on the sedimentations that are determined by the sensor, the magnetic force of the switchable hard magnet is set in such a way that sedimentations counteract, thereby obtaining a sedimentation-stable, magneto-rheological fluid.

In a version, periodic current pulses are provided in order to obtain a sedimentation-stable fluid with little expenditure of energy, where longer term deposits of particles are prevented.

In an advantageous version, the torque that must be applied in order to open the door, can only be adjusted via the magnetic force of the switchable hard magnet. The technical manufacturing costs are hereby kept to a minimum. A compact design is possible.

In an advantageous version, the holding force of the switchable hard magnet is set by the current pulses in order to accurately obtain a desired holding force and avoid the unnecessarily high expenditure of electric energy.

The coil includes a ferrite rod, with which the effect of the magnetic field that can be generated by the coil, can be suitably intensified. The coil and ferrite rod form the switchable hard magnet. The magnet core preferably comprises a permanent magnet, namely for instance AlNiCo. With the permanent magnet, low electrical outputs are enough to sufficiently solidify the magneto-rheological fluid to hold the motor vehicle door in position. If an opposing tension is generated in a version of the invention, this can reduce the effect of the permanent magnet. The mobility of the motor vehicle door can hereby be eased if necessary.

The coil is preferably arranged in an interior space where the interior walls are made from a magnetizable material, in particular from magnetizable steel. “From a magnetizable material” in this context is understood to mean a material that at least has sufficient permeability so that a magnetic field pushing through the material is intensified. This interior space is also called the lower interior space. By generating a corresponding electrical voltage on the coil, the magneto-rheological fluid can be solidified even better with little electrical power. The interior space where the coil is located is preferably formed by two disks and an interior wall section of a cap. The cap can then be rotated in relation to a disk. The other disk acts as a cover that creates an additional interior space within the cap. The magneto-rheological fluid is then within this additional interior space. The additional interior space that is also called the upper interior space, is then sealed liquid-tight. The interior walls of the additional interior space are then also preferably made from a magnetizable material in order to be able to solidify the magneto-rheological fluid even better with little electrical power.

In a version of the invention, a cap is thus sealed liquid-tight thanks to the aforementioned cover. The cap and cover form the additional or upper interior space that contains the magneto-rheological fluid. The cap for this embodiment is a component that can be moved relative to one or more other components of this interior space. A cap, for the purpose of this invention, is open towards a front side. The other front side is at least predominantly closed. Preferably it is closed in order to prevent contaminations in the space that is enclosed by the cap.

The cap is preferably connected torque-proof with a brake disk to achieve a high braking effect. The brake disk extends from a hollow cylindrical interior wall of the cap radially inwards into the interior space. In one version, the brake disk comes close to a sleeve and/or an axle, without however making contact with the sleeve or axle. There is still a gap between the brake disk and the sleeve or axle.

In principle, the brake disk, sleeve and/or axle are made from a non-magnetizable material, in order to prevent detrimental magnetic short-circuits. The desired solidification of the magneto-rheological fluid and with this, a braking effect, could be affected detrimentally by such a magnetic short-circuit.

The cap and/or the braking disk are preferably made from a magnetizable material, in particular from magnetizable steel, in order to be able to better solidify the magneto-rheological fluid with little electrical power.

The cap and braking disk are preferably separated by a component that is made from a non-magnetizable material. This can also prevent a detrimental magnetic short-circuit that could adversely affect the desired solidification of the magneto-rheological fluid and with this, the braking effect.

The component made from a non-magnetizable material connects the cap and braking disk torque-proof with one another, in order to connect both specified components torque-proof with one another with little assembly space and with a small number of parts. The rotary movement of the cap can be slowed down extremely well by the brake disk if necessary.

The brake disk adjoins to at least one fixed surface, namely in such a way that there is still a gap between the surface and the brake disk, where the magneto-rheological fluid is. If the magneto-rheological fluid is solidified in the gap, this then slows down the movement of the brake disk. Preferably, the brake disk is between two fixed surfaces, namely between two disks. The two disks are then mounted stationary in relation to the brake disk. There are still intermediate spaces between the two disks and the brake disk in the form of gaps, that contain the magneto-rheological fluid. The brake disk can be moved relative to the two disks. With this version, braking is improved even further. The width of the gap is small and is preferably less than 5 mm, preferably less than 1 mm, particularly preferred less than 0.5 mm, in order to be able to brake more effectively.

The aforementioned fixed surfaces or the one or more disks are preferably made from a magnetizable material, in particular from magnetizable steel, in order to be able to brake better with little electrical power.

A favorable design has the one or more disks connected torque-proof with a sleeve. The sleeve is mounted stationary relative to the brake disk.

The sleeve is preferably made from a non-magnetizable material, in particular from plastic, to prevent a magnetic short-circuit and thus consequential impairments of the braking effect.

The arrester device consists of a base plate that is made from a non-magnetizable material. This base plate is used to mount the arrester device to a motor vehicle or connect it to the door of a motor vehicle, without having to accept any power loss in terms of the braking effect.

The base plate can contain one or more holes that enable the base plate to be mounted in a fixed position to the motor vehicle or to the motor vehicle door.

In a version, an axle is preferably connected torque-proof with the cap. The axle is preferably made from a non-magnetizable material in order to prevent any power loss during the braking effect. The axle can be used for the rotational mounting of the cap. Once the axle is connected torque-proof with the cap, the axle can then be used as downthrust. In this case, the axle is fed out of the arrester device so that the fed-out part of the axle can be used as downthrust.

In a version, the space containing the magneto-rheological fluid has a sectionally meandering shape. Outwardly this space is restricted by the aforementioned cap and cover. In addition to this, the meandering shape is created by the aforementioned disks and by the brake disk. With this version, it is possible to brake with a particularly great force since the wall areas of the upper interior space also contribute to the braking effect.

In a version, the axle provides a sealable line that can be used to fill the designated areas in the upper interior space with the magneto-rheological fluid. The line therefore extends from the outside to the areas of the upper interior space that are designed for the magneto-rheological fluid. The line can be sealed.

An alternative or additional option is to provide a supply line in the cap that extends from the outside to the areas that are to be filled with the magneto-rheological fluid. This supply line can then also be sealed.

Surfaces that adjoin to the magneto-rheological fluid, are preferably covered with a non-magnetizable material such as plastic, to prevent deposits on the magnetizable surfaces.

The invention also relates to an arrester device with one or more of the aforementioned features, in other words, separate to a vehicle door.

The invention therefore particularly also relates to an arrester device with the characteristics of the additional claim. The claim dependent on this includes other characteristics that can preferably be combined with the object of the additional claim.

The invention is explained in further detail hereafter on the basis of an exemplary embodiment.

The following are shown:

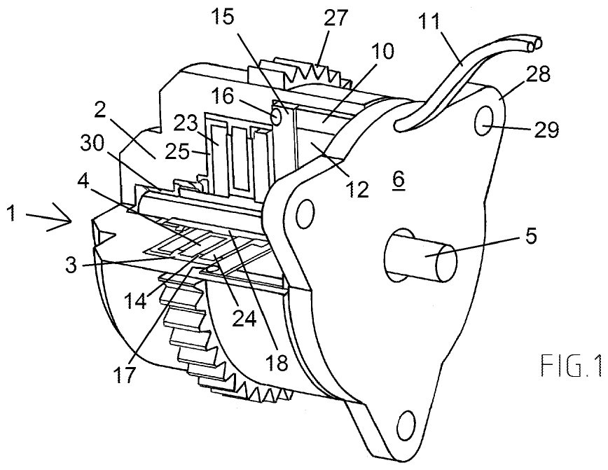

FIG. 1: an initial perspective view of an arrester device in a partly cut open state

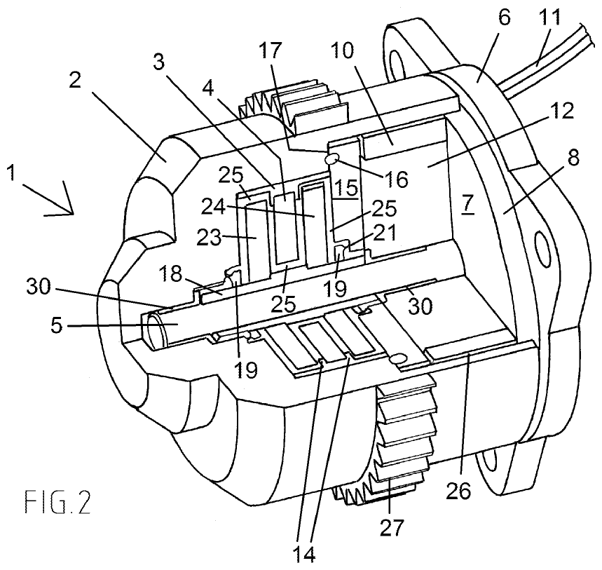

FIG. 2: a second perspective view of the arrester device

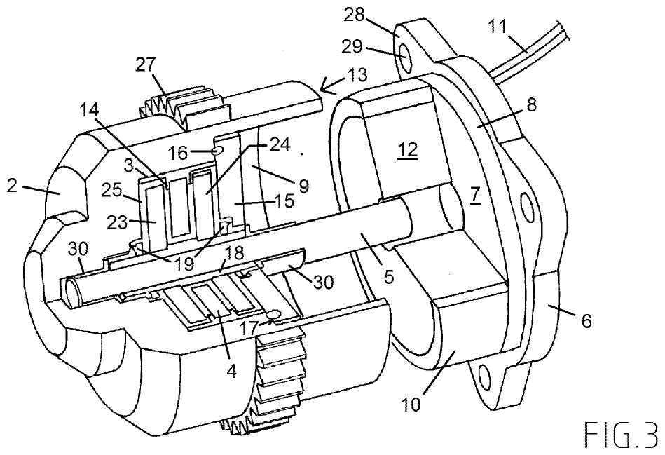

FIG. 3: another view of the arrester device

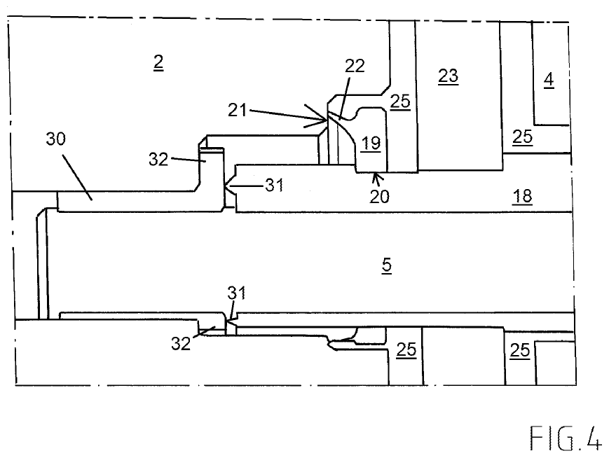

FIG. 4: enlarged section

The arrester device 1 shown in FIGS. 1 and 2 shows the components 2, 3 and 4 that are connected torque-proof with one another and that can be pivoted. The components 2, 3 and 4 therefore behave like a rigid body. These components 2, 3 and 4 are structured rotationally symmetrical and around the axle 5. The components 2, 3 and 4 can rotate around the longitudinal axis of the axle 5.

The component 2 is a cap-type housing—also called “cap” that is made from a magnetizable material and in the exemplary embodiment, is made from magnetizable steel. The cap 2 includes a cylindrical sheath that is closed on one front side and open on the other front side. The cap 2 can be manufactured as one part or several parts. If the cap 2 is manufactured as several parts, then it is made up of independently manufactured separate parts that have then been securely connected to one another.

The cap 2 that is primarily or completely made from a magnetizable material is open on one side and has an opening edge 13 (see FIG. 3) that adjoins a base plate 6. The cap 2 and the base plate 6 enclose a space. A disk 7 made from a magnetizable material, like the cap that is made from magnetizable steel, is mounted onto the base plate 6 that is made from a non-magnetizable material. The outer edge 8 of the disk 7 adjoins the interior wall 9 of the cap 2 (see FIG. 3). This means that the interior walls of the space that is created by the cap 2 and base plate 6, are made completely from a magnetizable material. This provides a cage made from a magnetizable material that intensifies the desired effect of the magnetic field that can be generated by the coil 10, in order to then be able to brake and hold an associated motor vehicle door in position with little energy expenditure.

A coil 10 is mounted onto the disk 7. The coil 10 adjoins the outer edge of the disk 7 and is located in the space that is created by the base plate 6 and cap 2. The space consists of two parts and includes an upper and a lower interior space. The lower interior space adjoins the disk 7. The lower interior space contains the coil 10. The interior walls of the lower interior space are made from magnetizable steel in order to intensify the desired effect of the magnetic field that can be generated by the coil 10.

An electrical connection 11 that powers the coil 10 during the operation, goes from the outer side through the base plate 6 and through the disk 7 to the coil 10 and has an electrically conductive connection to the coil ends. There is a core 12 within the coil 10 in the form of a permanent magnet that is made from AlNiCo. If a current flows through the coil 10, then, depending on the current direction, the magnetic field of the permanent magnet 12 can be intensified or weakened. The coil 10 and core 12 form the switchable hard magnet. Electrical pulses are also transmitted periodically to the coil 10 via the electrical connection even when not in use by a control unit which is not illustrated, in order to prevent longer-term deposits of particles (sedimentation) in the magneto-rheological fluid.

To prevent a magnetic short-circuit, the component 3 is a sleeve made from a non-magnetizable material, that is affixed to the adjoining interior wall of the cap 2. The sleeve 3, with the aid of two inward protruding lugs 14, encompasses the component 4 in a U-shape, whereby the component 4 is securely connected to the sleeve 3. The component 4 is a disk with a central hole to feed through the axle 5. The component 4 acts as a brake disk and is therefore also called brake disk 4. The sleeve 3 is made from plastic and protects the metal surface against deposits.

The space created by the cap 2 and base plate 6 is divided by a disk 15. The disk 15 is called the cover 15 since this disk 15 acts as a cover for the upper interior space that is hereby created. At the very least the areas of the upper interior space that contains the magneto-rheological fluid, are outwardly sealed liquid-tight. The upper interior space is the area that adjoins to the closed front side of the cap 2. To ensure that the cover 15 is adequately sealed liquid-tight, the cover 15 on the outer edge includes a circumferential ring seal 16 that is pressed against a stepped lug 17 of the cap 2.

The axle 5 goes into this upper interior space, namely through a sleeve 18 and through circumferential ring seals 19. The sleeve 18 allows the axle 5 to rotate and is therefore not firmly connected to it. The sleeve 18 is made from plastic and is therefore made from a non-magnetizable material. The sleeve 18 includes a recess 20—as shown in FIG. 4, into which the ring seals 19 extend. The respective ring seal 19 adjoins liquid-tight to the base of such a recess. Each ring seal 19 also has a circumferential lip 22 (see FIG. 4) that abuts liquid-tight on a stepped recess of the cover 15 or on a stepped recess 21 shown in FIG. 4.

Two disks 23 and 24 are connected torque-proof with the sleeve 18. Starting from the axle 5, the two disks 23 and 24 extend radially into the upper interior space, and in such a way that the brake disk 4 is between both disks 23 and 24. There is still a small gap-shaped space between the disks 23 and 24 and all interior walls of the upper part of the interior space. There is also a small gap-shaped intermediate space between the sleeve 3 and the disks 24 and 25. In addition to this, there is also a gap-shaped space between the brake disk 4 and the disks 23 and 24. Furthermore, the brake disk 4 only goes as far towards the sleeve 18 so that a gap-shaped space is left between the brake disk 4 and the sleeve 18, through which the axle 5 goes. This creates a space 25 that is cross-sectionally meander-shaped.

This cross-sectionally meander-shaped space 25 is not only sealed liquid-proof towards the cover 15 but also towards the closed front side of the cap 2, and namely in the same way as is shown on the larger scale in FIG. 4. The meander-shaped space 25 is filled with a magneto-rheological fluid.

The listed seals comprise one or more elastomers.

There is a gap 26 between the outer edge of the cover 15 and coil 10 and the adjoining interior wall of the cap 2, so as not to impede the rotational movement of the cap 2.

In the exemplary embodiment, the cap 2 is equipped with a gearwheel 27 along the outer circumference. The gearwheel 27 can for example be connected to a worm that in turn can be electrically powered by a drive. This makes it possible, with help from the drive, to rotate the cap 2 around the axle 5. The gearwheel is preferably made from a non-magnetizable material to ensure the braking effect is not adversely affected.

The base plate 6 that is made from a non-magnetizable material includes three laterally protruding tabs 28, through which the holes 29 pass. The base plate can hereby be affixed to a motor vehicle using the screw or groove joints fed through the holes 29.

The axle 5 is mounted by two bearing yokes 30. The axle 5 is connected torque-proof with the cap 2 so that the outward leading part of the axle 5 (see FIG. 1) can be used as downthrust. One bearing yoke 30 is located at the closed front side end of the cap 2. The other bearing yoke 30 extends into the permanent magnet 12.

If the outward leading part of the axle 5 is to be used as downthrust, then the axle 5 is connected torque-proof with the cap 2. In this case, the bearing yoke 30 shown in FIG. 4, that is located at the closed front side of the cap 2, connects the cap 2 with the axle 5. The axle 5 is then mounted in the sleeve 18 so that is can pivot and can therefore be rotated relative to the fixed sleeve 18. To keep frictional losses to a minimum during a rotary movement, the sleeve 18 encompasses a circumferential protruding nose 31 adjacent to a flange 32 of the sleeve 30. The radially protruding flange 32 of the sleeve 30 is then positioned on the nose 31, as is shown in large scale in FIG. 4. The sleeve 18 can then be securely connected to the lower bearing yoke 30, that in turn can be securely connected to the permanent magnet 12. Alternatively, or in addition to this, the sleeve 18 can then be connected torque-proof with the cover 15 for the purpose of a fixed attachment. The cover 15 cannot then be rotated together with the cap 2 and is thus mounted stationary, therefore for example connected torque-proof with the coil 10 and/or the magnetic core 12 of the coil. The coil 10 and magnetic core or permanent magnet 12 are mounted torque-proof to the base plate 6, namely by means of the disk 7.

The wall areas that adjoin to the magneto-rheological fluid are covered with a non-magnetizable material, in particular plastic, in order to prevent detrimental deposits on the magnetizable surfaces.

By applying a voltage to the coil 10, the magnetic field of the permanent magnet 12 can be increased or reduced. This enables a rotary movement of the cap 2 to be slowed down to standstill or the mobility to be increased. The structure on the whole ensures that small electrical currents can be used and that nevertheless a sufficiently large magnetic field can be applied to the magneto-rheological fluid in order to solidify the magneto-rheological fluid. The solidification can produce such a strong braking effect that the continuation of a rotary movement of a door or flap is significantly slowed down or is even almost completely prevented. In the basic state, when no voltage is applied to the coil 10, a rotary movement is possible but may be relatively difficult.

The motor vehicle door includes preferably one or more sensors, for instance one or more proximity sensors, that are used to open a door or flap. Such a voltage can be applied to the coil 10 via a control unit, so that the movement of the cap 2 is hereby increased. The door can then be swiveled with very little effort to either an open or closed position, for example through an electrical drive that engages into the gearwheel 27 by means of a worm. The protruding end of the axle 5 that is shown in FIG. 1, can then be used to introduce the rotary movement in a motor vehicle door for a movement in an opening or closing direction. Once the desired position of the door is reached, an opposing voltage is either applied or no voltage at all. In the first case, the door is held in position by a very high holding force, namely in any desired position. In the second case, the door can at least continue to be moved but with greater difficulty and is therefore also held in this position by a certain holding force.

In order to be able to open and close the door in a fully automated manner, it includes one or more proximity sensors that detect an approach to an obstacle. As a result, the opening movement of the door is stopped prior to reaching the obstacle, in order to prevent any damage.

### LIST OF REFERENCE SYMBOLS

1: Arrester device
2: Cap
3: Sleeve
4: Brake disk
5: Axle
6: Base plate
7: Magnetizable plate
8: Outer edge of the magnetizable disk
9: Interior wall of the cap
10: Coil
11: Electrical connection line
12: Coil core, permanent magnet
13: Opening edge of the cap
14: Protrusion
15: Cover
16: Circumferential gasket
17: Step
18: Sleeve
19: Circumferential seal ring
20: Indentation
21: Step
22: Protruding lip of the circumferential seal ring
23: Disk
24: Disk
25: Space filled with a magneto-rheological fluid 26: Gap
27: Gearwheel
28: Tab of the base plate
29: Hole in the tab
30: Bearing yoke
31: Protruding nose
32: Flange

1. A motor vehicle door comprising:
an arrester device including a magneto-rheological fluid for holding the motor vehicle door in an open position; and
a switchable hard magnet encompassing a coil for solidifying the magneto-rheological fluid that is arranged in the arrester device and is disposed adjacent to a liquid-tight interior space,
wherein the interior space contains one or more components which can be moved relative to one or more other components in the interior space, and
wherein a relative movement between the components is at least slowed down by solidifying the magneto-rheological fluid, whereby the motor vehicle door is held in the open position.

2. The motor vehicle door according to claim 1, wherein the switchable hard magnet is configured to provide a minimum magnetic force, whereby the magneto-rheological fluid is sedimentation-stable.

3. The motor vehicle door according to claim 2, wherein a torque that is applied to open the motor vehicle door can only be adjusted via the magnetic force of the switchable hard magnet.

4. The motor vehicle door according to claim 1 further comprising a control device through which current pulses can be introduced into the coil during operation.

5. The motor vehicle door according to claim 4, wherein the control device is configured to introduce recurring current pulses into the coil during operation.

6. The motor vehicle door according to claim 1, wherein the coil includes a coil core that is a permanent magnet and is made from AlNiCo.

7. The motor vehicle door according to claim 6, wherein the coil is positioned in another interior space defined by interior walls, wherein the interior walls are made from a magnetizable steel material.

8. The motor vehicle door according to claim 1 further comprising a cap that is sealed to be liquid-tight by a cover, wherein the cap and the cover form the interior space which contains the magneto-rheological fluid, and wherein the cap is one of the one or more components that can be moved relative to one or more other components in the interior space.

9. The motor vehicle door according to claim 8, wherein the cap is connected with a brake disk, wherein a connection between the cap and the brake disk is torque-proof.

10. The motor vehicle door according to claim 9, wherein the cap and/or the brake disk are made from a magnetizable steel material.

11. The motor vehicle door according to claim 10, wherein the cap and the brake disk are separated from one another by a component that is made from a non-magnetizable material.

12. The motor vehicle door according to claim 11, wherein the component that is made from the non-magnetizable material is the torque-proof connection between the cap and the brake disk.

13. The motor vehicle door according to claim 9, wherein the brake disk is arranged between two disks, wherein the brake disk can be moved relative to the two disks, and wherein an intermediate space is formed between the two disks and the brake disk, and contains the magneto-rheological fluid.

14. The motor vehicle door according to claim 1, wherein the one or more components include one or more disks that are made from a magnetizable steel material, wherein the one or more disks are connected with a sleeve by a torque-proof connection.

15. The motor vehicle door according to claim 14, wherein the sleeve is made from a non-magnetizable plastic material.

16. The motor vehicle door according to claim 1, wherein the arrester device includes a base plate that is made from a non-magnetizable material.

17. The motor vehicle door according to claim 16, wherein the base plate includes one or more holes that enable a fixed attachment of the base plate.

18. The motor vehicle door according to claim 8 further comprising an axle that is connected with the cap via a torque-proof connection, wherein the axle protrudes from the arrester device so that the axle can be used for down thrusting.

19. An arrester device for holding a motor vehicle door in an open position, the arrester device comprising:
a coil arranged in the arrester device that is configured to solidify a magneto-rheological fluid for holding the motor vehicle door in the open position wherein the coil is disposed adjacent to a liquid-tight interior space, wherein the interior space contains one or more components which can be moved relative to one or more other components in the interior space, wherein a relative movement between the components is at least slowed down by solidifying the magneto-rheological fluid and the slowing down of the relative movement causes the motor vehicle door to be held in the open position, wherein the coil comprises a coil core that is a permanent magnet and is made from AlNiCo, wherein the coil is positioned in another interior space defined by interior walls that are made from a magnetizable material; and
a cap that is sealed liquid-tight by a cover, wherein the cap and the cover form the interior space which contains the magneto-rheological fluid, wherein the cap is one of the one or more components that can be moved relative to one or more other components of the interior space, and wherein the coil is part of a switchable hard magnet that is electrically controlled to prevent deposits from being in the magneto-rheological fluid.

20. The arrester device according to claim 19, wherein the cap is connected with a brake disk via a torque-proof connection, wherein the cap and/or the brake disk are made from a magnetizable material, wherein the cap and the brake disk are separated by a component that is made from a non-magnetizable material and connects the cap and the brake disk via a torque-proof connection, wherein the brake disk is arranged between two disks and the brake disk can be moved relative to the two disks, wherein an intermediate space is defined between the disks and the brake disk and contains the magneto-rheological fluid, wherein the two disks are made from a magnetizable material, wherein the disks are connected to a sleeve via a torque-proof connection, wherein the sleeve is made from a non-magnetizable material, wherein the arrester device includes a base plate that is made from a non-magnetizable material and the base plate includes one or more holes that enable a fixed attachment of the base plate, wherein an axle is connected with the cap via a torque-proof connection and protrudes from the arrester device so that the axle can be used for down thrusting.
